(19) United States
(12) Patent Application Publication
(10) Pub. No.: US 2010/0176622 A1
(43) Pub. Date: Jul. 15, 2010

(54) METHOD OF PROVIDING A VEHICLE BODY WITH ONE OF FOUR DIFFERENT TOPS

(75) Inventors: Robert E. Fallis, III, Rochester, MI (US); Robert D. Wiechowski, Warren, MI (US); Jan Just, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Troy, MI (US)

(21) Appl. No.: 12/686,610

(22) Filed: Jan. 13, 2010

Related U.S. Application Data
(60) Provisional application No. 61/144,191, filed on Jan. 13, 2009.

(51) Int. Cl. B60J 7/00

(52) U.S. Cl. 296/107.08; 296/107.15

(57) ABSTRACT

A method of manufacturing a vehicle, alternatively, with a hardtop version, an entry level soft top module, a five-bow soft top module, or a retractable hardtop module. Any one of the four tops may be assembled on an automotive vehicle having a substantially common body structure with only minor modifications to the vehicle body being required to accept any one of the four different vehicle tops. A vehicle body architecture is provided that is configured to selectively receive one of four different style roofs on a roof mounting bracket that is attached to the side walls of the vehicle.

### CROSS-REFERENCE TO RELATED APPLICATIONS

This application claims the benefit of U.S. provisional application Ser. No. 61/144,191 filed Jan. 13, 2009.

### BACKGROUND OF THE INVENTION

1. Field of the Invention

The present invention relates to a method of providing an automotive vehicle with a compartment that is adaptable to accommodate one of four alternative tops, including a hard top, a convertible top with a fixed rear attachment, a convertible top having a movable rear bow that cooperates with a tonneau cover, and a retractable hardtop that cooperates with a tonneau and deck lid.

2. Background Art

Automobile manufacturers provide vehicles that generally have two roof styles that are made available to customers. Generally, all vehicles are available in a hardtop roof configuration and one of three different styles of openable roofs. One style of openable roof is a entry level “four-bow” convertible soft top that is connected to the vehicle body at the belt line between the rear light and deck lid. An upscale soft top may be provided that is referred to as a “five-bow” convertible top that has an articulated five bow that is raised and lowered by the top stack mechanism to provide clearance for an automatic tonneau. The automatic tonneau is raised to permit the convertible top to move into and out of a storage compartment. A retractable hardtop has rigid panels that are moved by the top stack linkage. Retractable hardtops generally have an automatic tonneau that is opened and closed with the deck lid to permit the retractable hardtop to be moved into and out of the storage compartment.

It has been proposed to provide a vehicle that offers a retractable hardtop and a soft top that uses the same linkage for articulating the top between extended and retracted positions. U.S. Pat. No. 7,377,574 discloses a retractable hardtop system that may be used to provide either a retractable hardtop or a retractable soft top. The same linkage is used to provide either a retractable soft top or the retractable hardtop versions of the vehicle. The '708 patent application does not disclose the concept of providing a power tonneau cover or two different types of soft tops as part of the system.

### SUMMARY OF THE INVENTION

Applicant proposes a method wherein a base vehicle may be provided that has a hardtop version, an entry level soft top module, a full-featured five-bow soft top module, or a full-featured retractable hardtop module. Any one of the four tops may be provided on an automotive vehicle having a substantially common body structure with only minor modifications to the vehicle body being required to accept any one of the four different vehicle tops.

According to another aspect of applicant's disclosure, a method of manufacturing a plurality of models of automotive vehicles is provided. The plurality of models includes a first model having a permanent roof, a second model having a basic convertible top roof that is fixed on a rear edge to the vehicle, a third model having a full featured convertible top roof that has a movable rear bow and that is stored below a tonneau, and a fourth model having a retractable hard top roof that is stored below a tonneau. Each model is assembled to a base vehicle by the method that comprises providing the base vehicle on an assembly line that defines a roof storage compartment, wherein the roof storage compartment has a right sidewall and a left sidewall. A roof mounting bracket is assembled to each of the right and left sidewalls. The roof mounting brackets then receive one of the permanent roof, the basic convertible top roof, the full featured convertible top roof, or the retractable hard top roof that is stored below a tonneau.

According to another aspect of applicant's disclosure, a vehicle body is provided that is configured to selectively receive one of a permanent roof, a retractable hardtop roof that may be stored below a tonneau, a soft top having a fixedly connected rear edge, and a soft top having an articulated rear most bow that may be stored below a tonneau. The permanent roof may feature a first set of body components for assembling the permanent roof to the vehicle including a deck lid that is connected by a hinge to the vehicle to selectively cover the trunk, a roof mounting bracket assembled to the inner side of two side walls of the top storage area, and a header bracket for securing a front edge of the permanent roof to a windshield header of the vehicle. The retractable hard top roof may feature a second set of body components for assembling the retractable hard top roof to the vehicle including the deck lid, a header receiver that receives the windshield header, a tonneau, and the roof mounting bracket. The soft top convertible with the fixedly connected rear most bow may feature a third set of body components for assembling the soft top convertible with the fixedly connected rear edge to the vehicle including the deck lid that is connected by a hinge to the vehicle, the header receiver, the roof mounting bracket, and a strut bracket for the deck lid. The soft top having an articulated rear most bow may feature a fourth set of body components for assembling the soft top having an articulated rear most bow the vehicle including the deck lid that is connected by a hinge to the vehicle, the header receiver, the roof mounting bracket, and the tonneau which is connected by a hinge to the vehicle.

These and other aspects of applicant's development will be more fully understood in view of the attached drawings and the following detailed description of the illustrated embodiments.

### BRIEF DESCRIPTION OF THE DRAWINGS

FIG. 1 is a fragmentary half-section rear/side perspective view of a four-bow convertible top in its fully extended position with the cover shown;

FIG. 2 is a fragmentary half-section rear/side perspective view of a four-bow top in its fully extended position with the cover removed;

FIG. 3 is a fragmentary half-section rear/side perspective view of a four-bow top in its mid-cycle position;

FIG. 4 is a fragmentary half-section rear/side perspective view of a four-bow top in its nearly fully retracted position;

FIG. 5 is a fragmentary half-section rear/side perspective view of a four-bow top fully stowed in a storage compartment;

FIG. 6 is a fragmentary half-section rear/side perspective view of a five-bow convertible top in its fully extended position;

FIG. 7 is a fragmentary half-section rear/side perspective view of a five-bow convertible top in an early retraction position;

FIG. 8 is a fragmentary half-section rear/side perspective view of a five-bow convertible top in its mid-cycle position;

FIG. 9 is a fragmentary half-section rear/side perspective view of a five-bow convertible top in its nearly fully retracted position with the tonneau open;

FIG. 10 is a fragmentary half-section rear/side perspective view of a five-bow convertible top fully stowed in the storage compartment;

FIG. 11 is a fragmentary half-section rear/side perspective view of a retractable hardtop in its fully extended position;

FIG. 12 is a fragmentary half-section rear/side perspective view of a retractable hardtop in its mid-cycle position with the tonneau closed;

FIG. 13 is a fragmentary half-section rear/side perspective view of a retractable hardtop in its mid-cycle position with the tonneau open;

FIG. 14 is a fragmentary half-section rear/side perspective view of a retractable hardtop fully stowed in the storage compartment with the tonneau open;

FIG. 15 is a fragmentary half-section rear/side perspective view of a retractable hardtop fully stowed in the storage compartment with the tonneau cover closed; and

FIG. 16 is a fragmentary half-section rear/side perspective view of a hardtop.

### DETAILED DESCRIPTION OF THE PREFERRED EMBODIMENT(S)

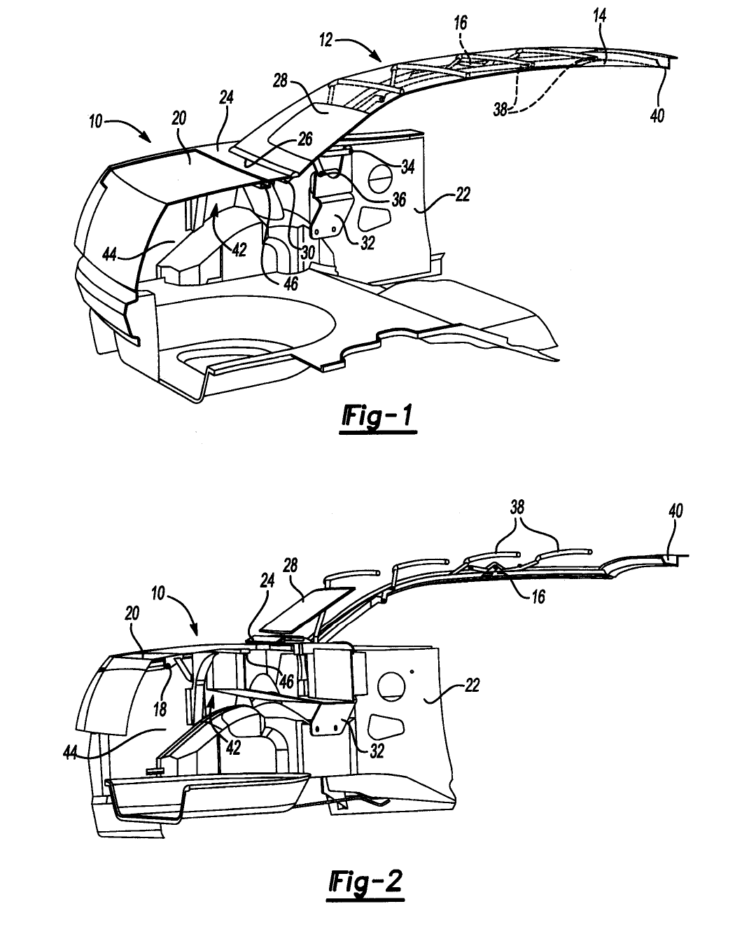

Referring to FIGS. 1 and 2, a vehicle 10 is partially illustrated. As illustrated, the vehicle 10 may be referred to as a body-in-white. A fixed rear bow top module 12 is shown in its extended position in FIG. 1 with the flexible fabric cover 14 supported by the top stack linkage 16. As shown in FIG. 2, the top stack linkage 16 is shown without the cover 14.

A hinge 18 secures a deck lid 20 to an inner surface of a body-in-white sidewall 22. The deck lid 20 is pivoted on the hinge 18 to open and close the deck lid 20 when loading or unloading the trunk.

A trim panel 24 comprising a static panel is disposed between the deck lid 20 and the convertible top 12. A rear edge 26 of the top module 12 is provided below and rearward of a back light 28 that is supported by the cover 14 of the convertible top module 12. A tack strip 30 secures the rear edge 26 of the convertible top module 12. The tack strip 30 secures the rear edge 26 of the convertible top module 12 so that it is fixed to the trim panel 24. A side body bracket 32 is secured to the inner surface of the body-in-white sidewall 22. While the drive mechanism and top stack linkage 16 may take various forms, as illustrated, a front link 34 and a rear link 36 are secured to the side body bracket 32 and the top stack linkage 16. The front link 34 and rear link 36 are part of a four-bar link that may be power driven or manually operated to extend and retract the convertible top module 12.

The top stack linkage 16 includes a plurality of bows 38 that extend in the transverse vehicle direction to support the cover 14. A header attachment bow 40 is used to secure the convertible top module 12 to a vehicle windshield header (not shown). The cover 14 is attached to the header attachment bow 40 and extends between the header attachment bow 40 and the rear edge 26 of the convertible top module 12. A storage compartment 42 is provided immediately below the deck lid 20. The storage compartment 42 may be partitioned from the trunk of the vehicle, or may be provided within the trunk 44 of the vehicle without dividers. A water management rail 46 is provided to channel water that flows between the deck lid 20 and the trim panel 24 toward the sides of the vehicle 10.

The convertible top module 12 may be assembled to the vehicle 10 as described below. A standard body-in-white vehicle is provided with the side body brackets 32 that are assembled to the inner surface of the sidewalls 22 on both sides of the vehicle. The water management rail 46 is also assembled to the body between the inner surfaces of the sidewalls 22 on opposite sides of the vehicle 10. A checking fixture (not shown) may be used to measure the distance between the side body bracket 32 and the windshield header (not shown). Once the location of the side body brackets 32 are confirmed, the hinge 18 is assembled to the inner surface of the sidewall 22. The deck lid 20 is then assembled to the hinge 18. The soft top convertible module 12 is then assembled to the side body brackets 32 and the front and rear links 34 and 36 are secured between the side body brackets 32 and the top stack linkage 16.

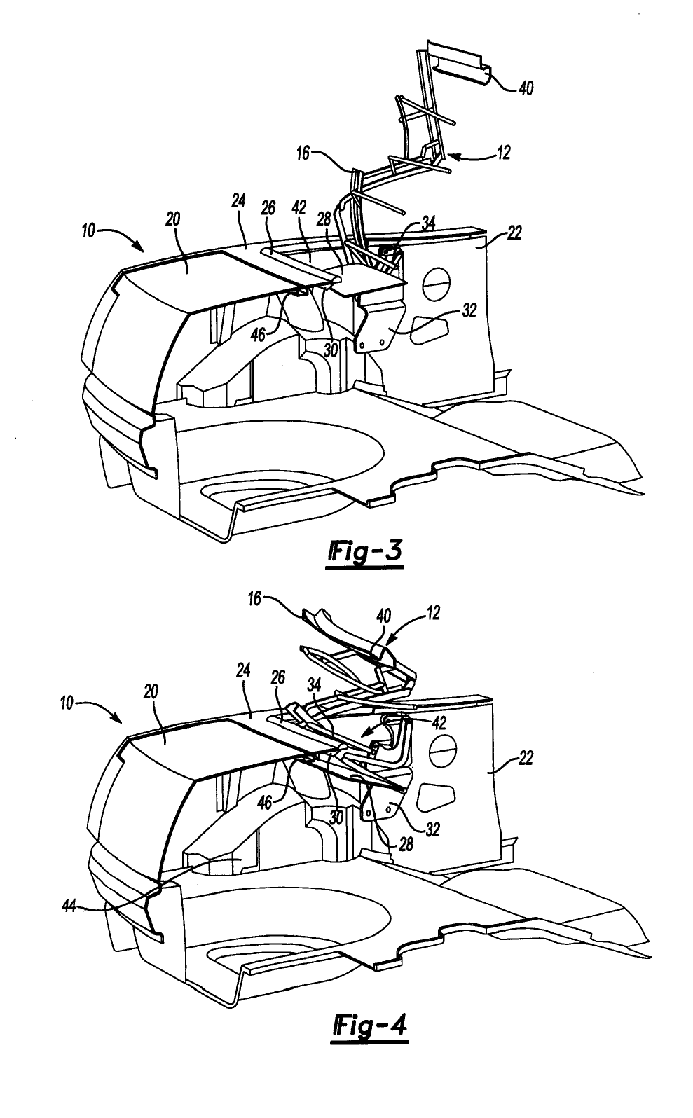

Referring to FIGS. 3 and 4, the convertible top module 12 is shown in two different phases of the extension/retraction cycle. Throughout the extension/retraction cycle, the trim panel 24 remains in a fixed position. The rear edge 26 of the convertible top module 12 is fixed to the tack strip 30 at all times thereby establishing a seal between the convertible top module 12 and the vehicle 10. The back light 28 is shown disposed within the storage compartment 42.

As shown in FIG. 4, the remainder of the top stack linkage 16 and the cover 14 (not shown) are shown as they are folded into the storage compartment on top of the back light 28. As shown, the storage compartment 42 does not include dividers or panels that separate the storage compartment 42 from the trunk 44, but it should be understood that such dividers or walls could be provided if necessary.

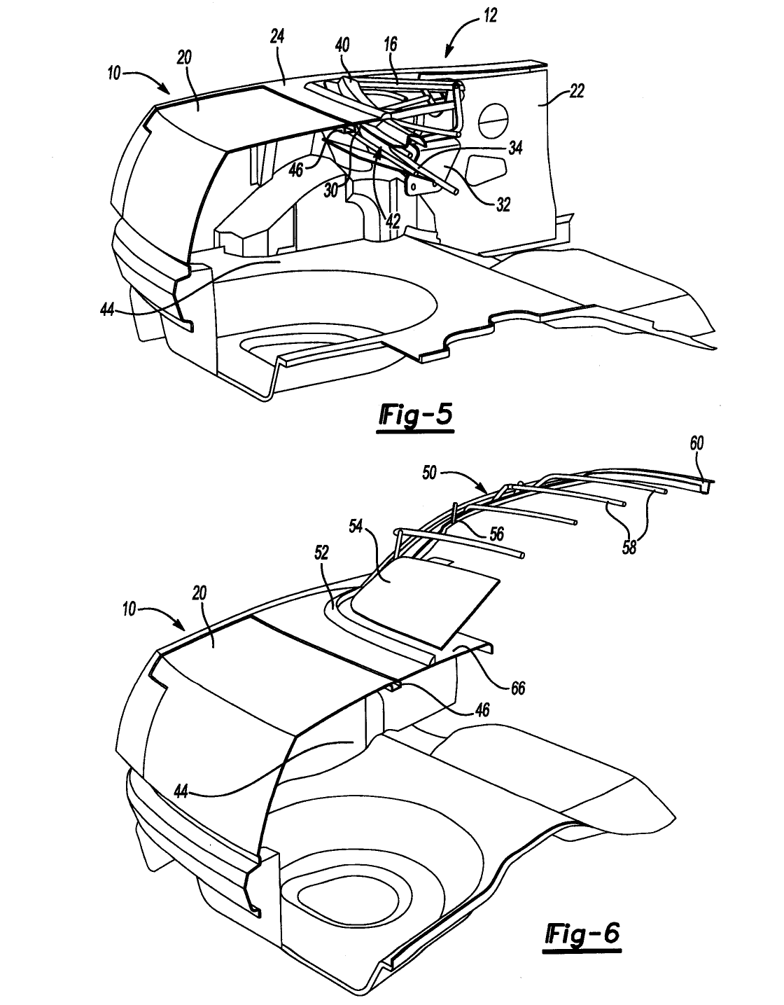

Referring to FIG. 5, the convertible top module 12 is shown stowed within the vehicle 10 in the storage compartment 42. The trim panel 24 remains in the same position throughout the cycle and the convertible top is stored without being covered by an automatic tonneau panel that may be provided with other styles of retractable roofs as described below.

Referring to FIG. 6, an articulated rear bow convertible top module 50 is illustrated without the fabric cover to provide better visibility. The convertible top module 50 is provided with a cover (not shown) that is substantially the same as the cover illustrated in FIG. 1. The convertible top module 50 includes an articulated rear bow 52 that lies on the body, generally at the belt line of the body, behind the rear window 54 of the convertible top module 50. The articulated rear bow 52 is part of a top stack linkage 56 that extends from near the deck lid 20 to the windshield header (not shown) of the vehicle 10. A plurality of bows 58 extend in the transverse vehicle direction and are connected to the top stack linkage 56. A header attachment bow 60 is provided at the forward end of the convertible top module 50 which is adapted to be secured to the windshield header (not shown) as is well known in the art.

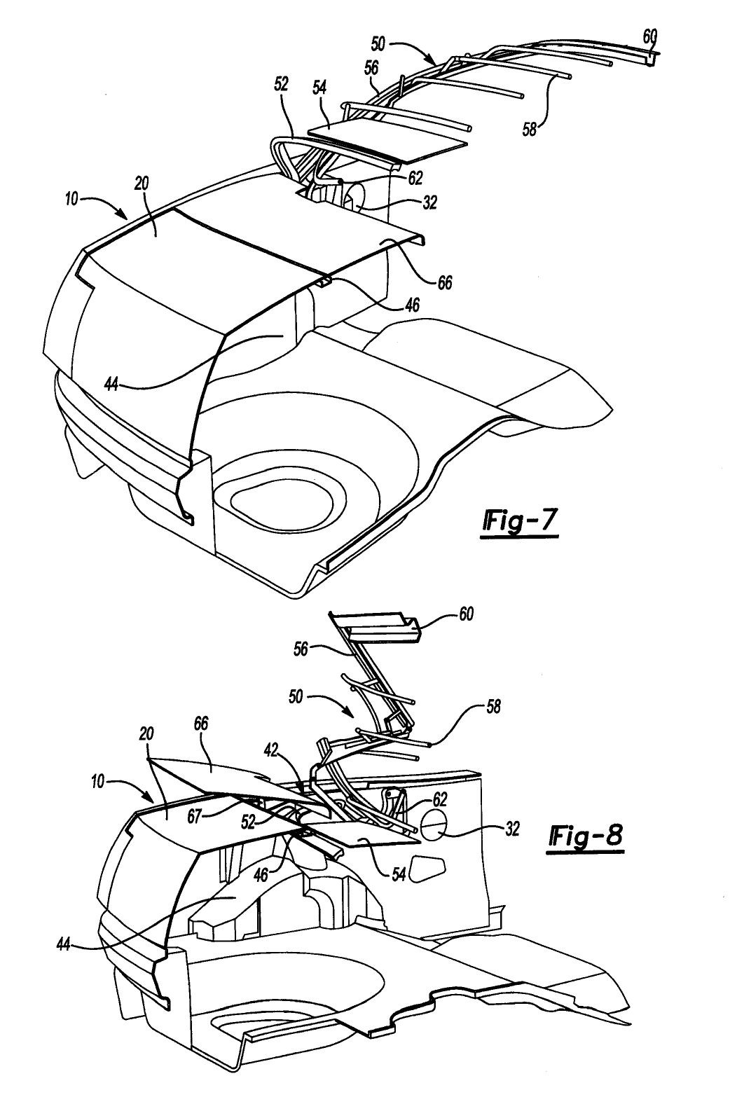

Referring to FIG. 7, the vehicle 10 is shown with the articulated rear bow convertible top module 50. As illustrated in FIG. 7, the articulated rear bow 52 is raised by a rear bow pivot bracket 62 that is assembled to a side body bracket 32. When the articulated rear bow 52 is raised, the rear window 54 is also raised and tension on the cover (not shown) is released. The top stack linkage 56 is connected to a plurality of bows 58 and the header attachment bow 60. The rear bow pivot bracket 62 may be actuated by a fluid cylinder or motor to raise the rear bow 52 as is well known in the art. A tonneau 66 is shown in a lowered position wherein it forms an extension of the deck lid 20 and provides a surface against which the rear bow 52 lies when the top is in its extended position.

Referring to FIG. 8, the vehicle 10 is shown with the tonneau 66 raised and shifted rearwardly on a tonneau hinge, or link, 67 to a position generally over the deck lid 20. The tonneau 66 is moved by a tonneau linkage comprising a four-bar link or other similar linkage that raises the tonneau 66 to provide clearance for the top stack linkage 56, the rear bow 52, bow 58 and header attachment bow 60 to be stored in a storage compartment 42 or trunk 44 of the vehicle 10. As shown in FIG. 8, the convertible top module 50 is stored in the upper area of the trunk 44. However, it should be understood that partitions or other structures may be provided between trunk 44 to define the storage compartment 42. In FIG. 8, the top stack linkage 56 is retracted to a mid-cycle position and the header attachment bow 60 is pivoted over the convertible top module 50. The rear window 54 is shown being lowered into the trunk 44 with the articulated rear bow 52. The top stack linkage 56 is anchored to the side body bracket 32 as was previously described with reference to the embodiments of FIGS. 1-5.

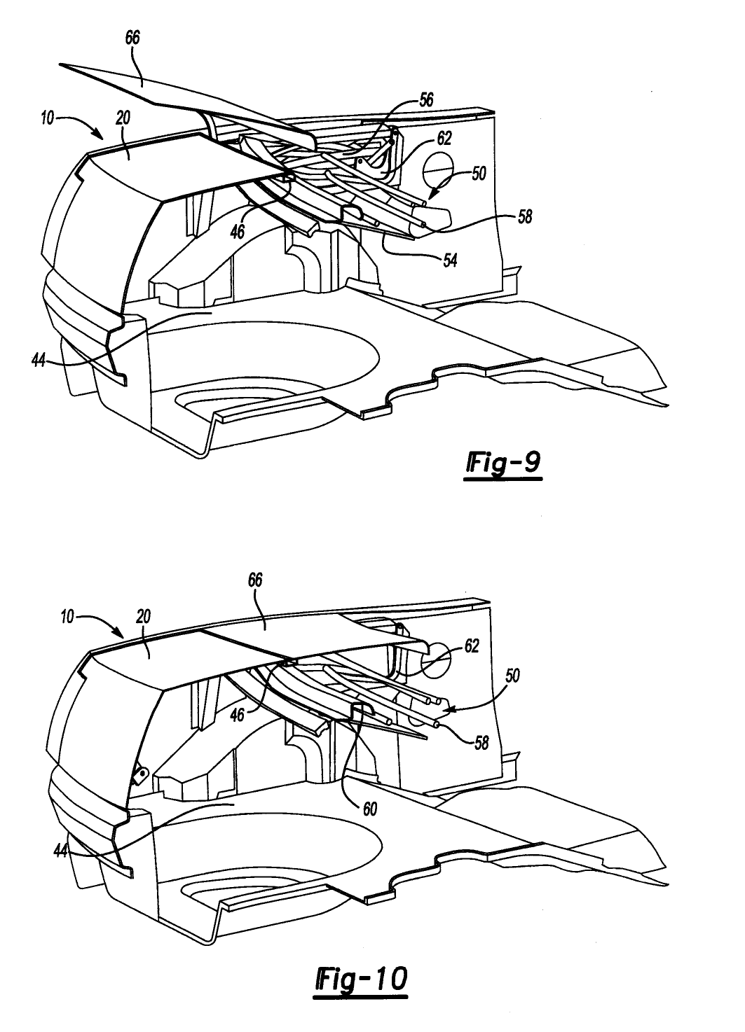

Referring to FIG. 9, the convertible top module 50 is shown fully retracted into the trunk 44. The tonneau 66 remains in its open or raised position in which it overlies the trunk 20.

Referring to FIG. 10, the convertible top module 50 is shown fully stowed with the tonneau 66 returning to its closed position in which the tonneau 66 is generally aligned with the deck lid 20. The top stack linkage 56, bows 58, and header attachment bow 60 are all stored below the tonneau 66 in the trunk 44.

The embodiment of FIGS. 6-10 may be assembled to the vehicle 10 as described below. Body side brackets 32 are assembled to the inner surface of the sidewall 22. A water management rail 46 is then assembled to the side brackets 32. A checking fixture may be used to measure the distance between the side bracket and the windshield header. The deck lid hinge 18 (shown in FIG. 2) and tonneau cover hinge 67 are installed on the sidewall 22. The deck lid 20 is attached to the deck lid hinge 18 and the tonneau 66 is assembled to the tonneau hinge 67. The deck lid 20 and tonneau cover 66 are shown as they are being moved to their closed position. The tonneau cover 66 is then moved to an open position and the soft top convertible module 50 is assembled to the vehicle's side body bracket 32. Finally, the tonneau cover is closed over the soft top module to complete assembly of the articulated rear bow convertible top module 50 to the vehicle 10.

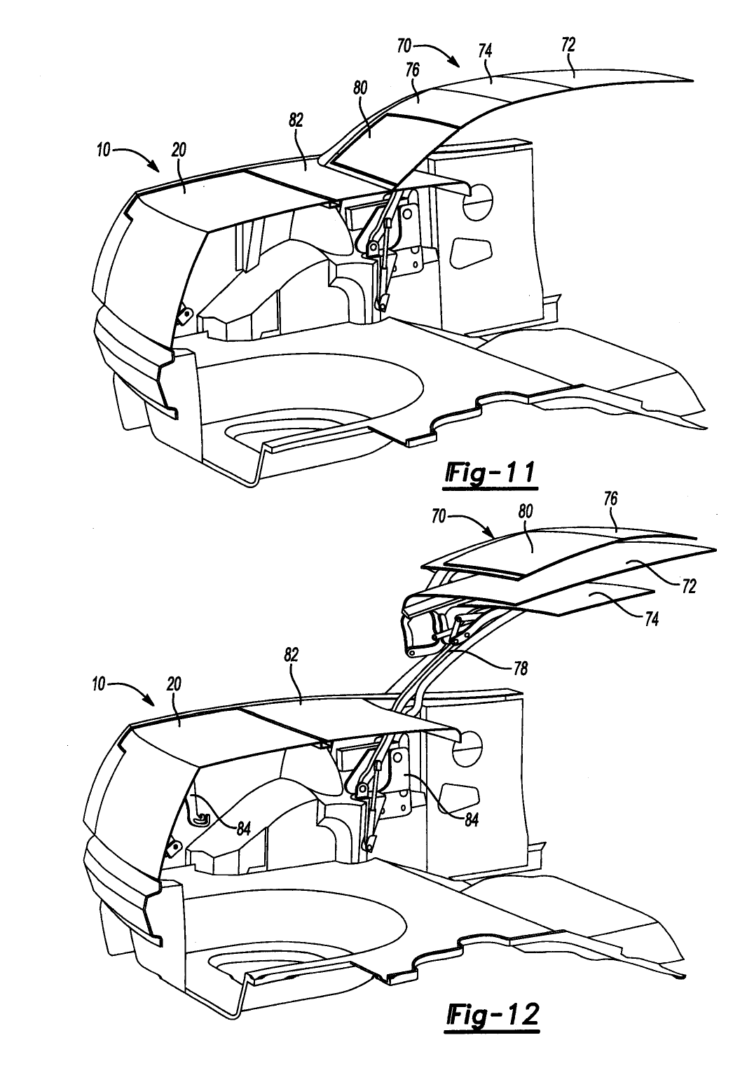

Referring to FIG. 11, a retractable hardtop module 70 is shown in its extended position. The retractable hardtop module 70 includes a front panel 72, a central panel 74 and a rear panel 76.

Referring to FIGS. 11 and 12, the retractable hardtop module 70 includes a top stack linkage 78 that is retracted by raising the rear panel 76 that includes a rear window 80 to a position above the front panel 72. The front panel 72 is shifted by the top stack linkage 78 to a position overlying the central panel 74. In FIGS. 11 and 12, a rear pivot tonneau 82 is shown in its closed position closing the storage compartment.

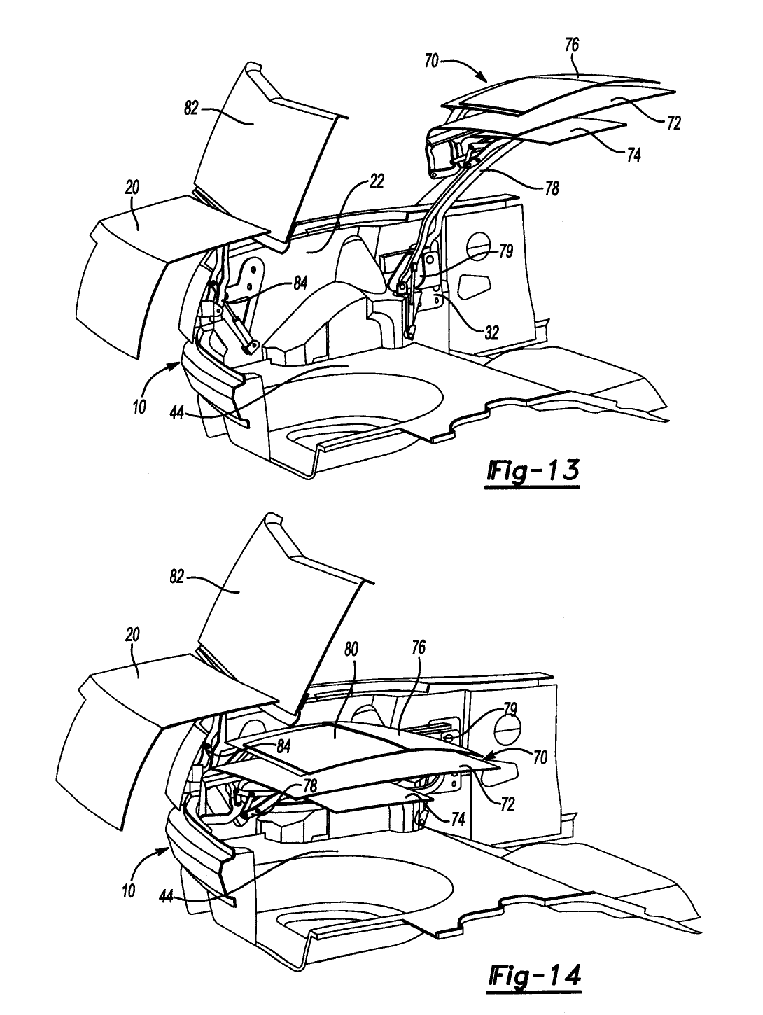

Referring to FIG. 13, the retractable hardtop module 70 is shown secured to the side body bracket 32. A retractable hardtop pivot bracket 79 is secured to the side body bracket 32 that is mounted to the inner surface of the body-in-white sidewall 22, as previously described with regard to the embodiments of FIGS. 1-5 and 6-10. A rear pivoting tonneau 82 is shown in conjunction with the deck lid 20 of the vehicle 10. The rear pivot tonneau 82 is secured to a deck lid/tonneau linkage 84 that links the deck lid 20 and tonneau 82 to the vehicle sidewall 22. The deck lid/tonneau linkage 84 secures the deck lid 20 and tonneau 82 together and moves them to provide clearance to the trunk for passage of the retractable hardtop module 70.

Referring to FIG. 14, the vehicle is shown with the retractable hardtop module 70 retracted and stored in the trunk 44 of the vehicle 10. The deck lid 20 and rear pivot tonneau 82 remain in their open and rearwardly shifted position and the top stack linkage 78 including the front panel 72, central panel 74 and rear panel 76 are shown stacked and stowed in the trunk 44.

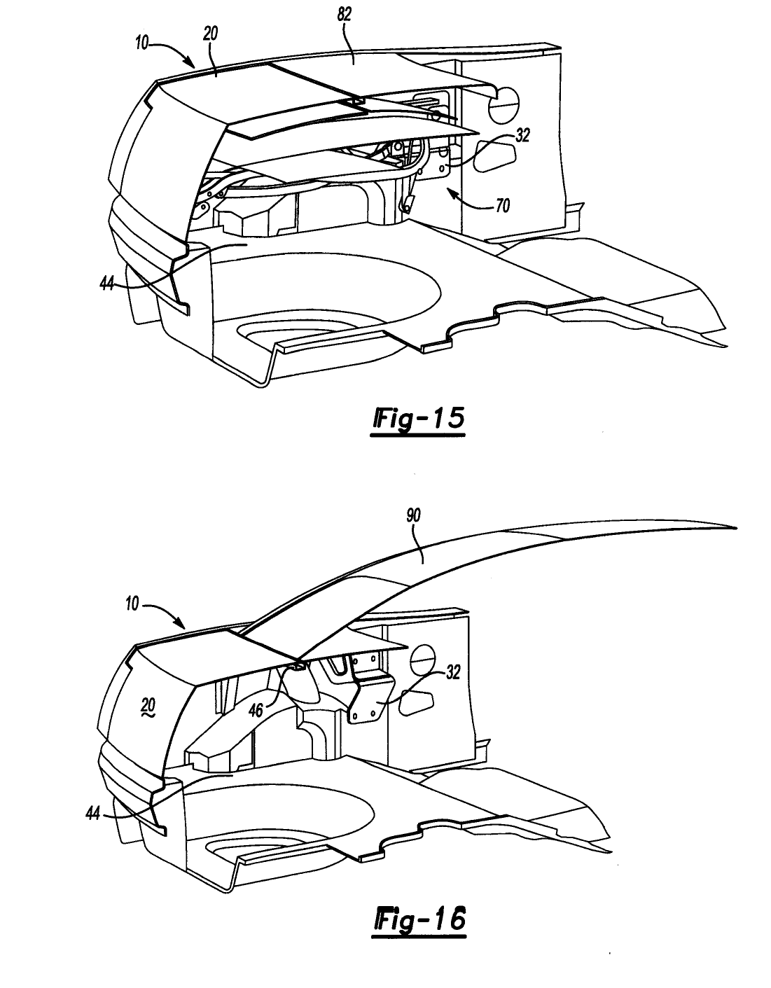

Referring to FIG. 15, the retractable hardtop module 70 is shown stored in the trunk 44 of the vehicle 10. The deck lid 20 and rear pivot tonneau 82 are shown in their closed position having been returned to the closed position by the deck lid/tonneau linkage 84.

Referring to FIGS. 11-15, the method of assembling the retractable hardtop module 70 will be described below. The body side bracket 32 is attached to the inner surface of the body-in-white sidewall 22. A checking fixture may be used to measure the distance from the windshield header and the side body bracket. The deck lid and tonneau linkage 84, or hinge, is assembled to the inner surface of the body-in-white sidewall 22. The deck lid panel and tonneau panel are then assembled to the deck lid tonneau hinge linkage 84. The retractable hardtop module 70 may then be attached to the side body brackets 32. A storage enclosure (not shown) may then be assembled to the vehicle trunk. Alternatively, the storage enclosure may be omitted and the retractable hardtop may be stored directly within the trunk 44. The retractable hardtop is then indexed toward its closed, or extended, position and the retractable hardtop is closed to complete the assembly process.

Referring to FIG. 16, a hard top module 90 is shown secured to the vehicle 10. The hard top module may be assembled to the vehicle with or without the side body bracket 32. The hard top module 90 extends from the deck lid 20 of the vehicle to the windshield (not shown). The water management rail 46 is previously described as provided at the juncture of the hard top module 90 and its rear edge and the deck lid 20.

Assembly of the hard top for a coupe or sedan styled vehicle is assembled as described below. The side body brackets 32 are assembled to the inner surface of the sidewall 22. A water management rail 46 is then assembled to the vehicle to extend transversely across the vehicle between the side brackets 32. A checking fixture may be placed on the body bracket to check the distance between the windshield header and the side bracket. A deck lid hinge mechanism of conventional design may be assembled to the side of the vehicle 10. The deck lid may then be assembled to the deck lid hinge mechanism. The hard top roof may then be assembled to either the sidewalls 22 or to the side brackets 32 and windshield header.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

We claim:

1. A method of manufacturing a plurality of models of automotive vehicles including a first model having a permanent roof, a second model having a basic convertible top roof that is fixed on a rear edge to the vehicle, a third model having a full featured convertible top roof that has a movable rear bow and that is stored below a tonneau, and a fourth model having a retractable hard top roof that is stored below a tonneau, wherein each model is assembled to a base vehicle, the method comprising:
providing the base vehicle on an assembly line that defines a roof storage compartment, wherein the roof storage compartment has a right sidewall and a left sidewall;
assembling a roof mounting bracket to each of the right and left sidewalls; and
assembling to the roof mounting brackets one of:
the permanent roof,
the basic convertible top roof that is fixed on a rear edge to the vehicle,
the full featured convertible top roof that has a movable rear bow and that is stored below a tonneau, and
the retractable hard top roof that is stored below a tonneau.

2. The method of claim 1 wherein the basic convertible top is assembled to the base vehicle with the following steps:
assembling a water management rail to the body between the right and left sidewalls;
assembling a pair of hinges to each of the right and left sidewalls;
assembling the deck lid to the hinges;
assembling the basic convertible top to the roof mounting brackets; and
attaching a rear edge of the basic convertible top to a tack strip.

3. The method of claim 2 wherein the step of attaching the basic convertible top further comprises securing a front link and a rear link between the roof mounting brackets and a top stack linkage of the basic convertible top.

4. The method of claim 1 wherein the full featured convertible top is assembled to the base vehicle with the following steps:
assembling a water management rail to the body between the right and left sidewalls;
assembling a pair of hinges to each of the right and left sidewalls;
assembling the deck lid and the tonneau to the hinges;
moving the tonneau to an open position; and
assembling the full featured convertible top to the roof mounting brackets.

5. The method of claim 4 wherein the tonneau cover is attached to the deck lid with a four bar link and the moveable rear bow is operatively connected as part of the full featured convertible top to the roof mounting brackets, the method further comprising:
raising the tonneau on the four bar link to open the storage compartment as the full featured convertible top is extended and retracted; and
assembling the full featured convertible top to the roof mounting brackets with the rear bow in its raised position.

6. The method of claim 1 wherein the retractable hard top roof is assembled to the base vehicle with the following steps:
assembling a pair of hinges to each of the right and left sidewalls;
assembling the deck lid and the tonneau to the hinges;
assembling the retractable hard top to the roof mounting brackets; and
indexing the retractable hard top to the extended position.

7. The method of claim 1 wherein the permanent roof is assembled to the base vehicle with the following steps:
assembling a water management rail to the body between the right and left sidewalls;
assembling a pair of hinges to each of the right and left sidewalls;
assembling the deck lid to the hinges; and assembling the permanent roof to the vehicle.

8. The method of claim 7 wherein the step of assembling the permanent roof includes the step of attaching the permanent roof to the roof mounting brackets and a windshield header.

9. A vehicle body defining a passenger compartment, a top storage area and a trunk, wherein the vehicle body is configured to selectively receive one of a permanent roof, a retractable hardtop roof that may be stored below a tonneau, a soft top having a fixedly connected rear edge, and a soft top having an articulated rear most bow that may be stored below a tonneau, the vehicle body further comprising one of the following combinations:
the permanent roof and a first set of body components for assembling the permanent roof to the vehicle including a deck lid that is connected by a hinge to the vehicle to selectively cover the trunk, a roof mounting bracket assembled to the inner side of two side walls of the top storage area, and a header bracket for securing a front edge of the permanent roof to a windshield header of the vehicle;
the retractable hard top roof and a second set of body components for assembling the retractable hard top roof to the vehicle including the deck lid, a header receiver that receives the windshield header, a tonneau, and the roof mounting bracket;
the soft top convertible with the fixedly connected rear most bow and a third set of body components for assembling the soft top convertible with the fixedly connected rear edge to the vehicle including the deck lid that is connected by a hinge to the vehicle, the header receiver, the roof mounting bracket, and a strut bracket for the deck lid; and
the soft top having an articulated rear most bow and a fourth set of body components for assembling the soft top having an articulated rear most bow the vehicle including the deck lid that is connected by a hinge to the vehicle, the header receiver, the roof mounting bracket, and the tonneau which is connected by a hinge to the vehicle.

10. The vehicle body of claim 9 further comprising a water trough that extends across the vehicle in a transverse direction between the trunk and the top storage area.

11. The vehicle body of claim 9 wherein the permanent roof, the retractable hardtop roof, the soft top having a fixedly connected rear edge, and the soft top having an articulated rear most bow are each preassembled as modules that may be selectively married to the vehicle body.
